(19) United States
(12) Patent Application Publication
(10) Pub. No.: US 2010/0033571 A1
(43) Pub. Date: Feb. 11, 2010

(54) TRAFFIC INFORMATION DETECTOR, TRAFFIC INFORMATION DETECTING METHOD, TRAFFIC INFORMATION DETECTING PROGRAM, AND RECORDING MEDIUM

(75) Inventors: Ryujiro Fujita, Saitama (JP); Kohei Ito, Saitama (JP)

Correspondence Address: FOLEY AND LARDNER LLP;SUITE 500, 3000 K STREET NW, WASHINGTON, DC, 20007, US

(73) Assignee: Pioneer Corporation

(21) Appl. No.: 12/442,998

(22) PCT Filed: Sep. 28, 2006
(86) PCT No.: PCT/JP2006/319329

§ 371 Date: Apr. 28, 2009

(51) Int. Cl. H04N 7/18

(52) U.S. Cl. 348/149; 348/E07.085

(57) ABSTRACT

A traffic information detecting apparatus includes a camera; a driving unit that is equipped with the camera and defines a shooting direction of the camera; an image processing unit that executes predetermined processing with respect to an image of a traffic signal captured by the camera and detects a state of the traffic signal; and a control unit that drives the driving unit based on a detection result of the image processing unit. The image processing unit further recognizes a light type of the traffic signal from an image of a road along which a vehicle is traveling, the image of the road being captured by the camera; and according to the light type detected by the image processing unit, the control unit drives the driving unit to enable the shooting direction of the camera to be defined.

### TECHNICAL FIELD

The present information relates to a traffic information detecting apparatus that acquires images of the surroundings of a road traveled, by properly controlling a camera disposed on a vehicle to detect useful traffic information from the acquired images, a traffic information detecting method, a traffic information detecting program, and a recording medium.

### BACKGROUND ART

Conventionally, technology has been proposed to acquire image information of the surroundings of a road on which a vehicle is traveling by maintaining the shooting direction of a camera (see, for example, Patent Document 1). This technology involves driving a camera in the vertical direction depending on changes in the slope of the road traveled and keeping the road vanishing point in the acquired images near the center of a screen.

Patent Document 1: Japanese Patent Laid-Open Application Publication No. 2000-255319

### DISCLOSURE OF INVENTION

### Problem to be Solved by the Invention

Although the conventional technology above is suitable for recognizing obstacles or vehicles ahead on a road traveled, if the camera is aimed at the road vanishing point, there may be occasions where traffic signals are out of the view angle of the camera and cannot be detected.

In particular, in the case of a traffic signal after a sharp, blind bend, when the traffic signal comes in to view, the traffic signal is located on the upper side and, therefore, when the shooting direction of the camera is set to keep the road vanishing point near the center, it is problematic that the traffic signal does not come into the view angle of the camera and a failure of an initial detection of the traffic signal cannot be prevented.

In the case of omnidirectional cameras or wide-angle cameras, wide-range photographing is performed by a lens for the same effective resolution of a sensor and, therefore, it is problematic that the necessary resolution may not be acquired for detecting the traffic signals and that the detection is enabled only when the cameras come into close proximity of the traffic signal.

### Means for Solving Problem

A traffic information detecting apparatus according to the invention of claim 1 includes a camera; a driving unit equipped with a camera, the driving unit defining a shooting direction of the camera; an image processing unit that executes a predetermined process for an image of a traffic information displaying device photographed by the camera to detect a state of the traffic information displaying device; and a control unit that drives the driving unit based on the detection result of the image processing unit.

A traffic information detecting method according to the invention of claim 11 includes a road vanishing point detecting step of detecting a road vanishing point from a photographed traveling road image; a road vanishing point tracking step of driving a camera to enable the road vanishing point detected at the road vanishing point detecting step to be displayed at a predetermined position in a traveling road image; a signal detecting step of detecting a traffic signal from a photographed traveling road image; a signal tracking step of driving a camera after a traffic signal is detected at the signal detecting step to enable a change in a light type of the traffic signal to be monitored if it is determined that a light type of the traffic signal is a light type requiring a stop or deceleration; and a vehicle stop period operation step of detecting a change in a light type of the traffic signal monitored at the signal tracking step to output the detection result if a vehicle stops.

A traffic information detecting program according to the invention of claim 12 causes a computer to execute the traffic information detecting method according to claim 11.

A computer-readable recording medium according to the invention of claim 13 stores therein the traffic information detecting program according to claim 12.

### BRIEF DESCRIPTION OF DRAWINGS

FIG. 1 is a block diagram of a functional configuration of a traffic information detecting apparatus according to an embodiment of the present invention;

FIG. 2 is a flowchart of an example of processing by the traffic information detecting apparatus according to the embodiment of the present invention;

FIG. 3-1 is a diagram depicting an example of a road condition to be detected;

FIG. 3-2 is a diagram depicting an example of a road condition to be detected;

FIG. 4 is a schematic of an exemplary image of a road captured by a camera after initialization processing;

FIG. 5 is a flowchart of road vanishing point detection processing;

FIG. 6 is a diagram for explaining calculation of road vanishing point coordinates;

FIG. 7 is a flowchart of processing for tracking the road vanishing point;

FIG. 8 is a diagram for explaining the processing for tracking the road vanishing point;

FIG. 9 is an image diagram of the image of the road after the processing for tracking the road vanishing point;

FIG. 10 is a diagram of a traffic signal detection area;

FIG. 11 is a flowchart of processing for tracking a traffic signal;

FIG. 12-1 is a diagram for explaining the traffic signal tracking processing;

FIG. 12-2 is a diagram for explaining the traffic signal tracking processing;

FIG. 13 is a flowchart of operations during stop of the vehicle; and

FIG. 14 is a diagram for explaining a technique of calculating a traffic signal change detection area.

### EXPLANATIONS OF LETTERS OR NUMERALS

100 traffic information detecting apparatus
101 driving unit
102 control unit
103 sensor unit
104 storage unit
105 information input unit
106 information output unit
107 vehicle information interface (I/F)
108 external device interface (I/F)
109 image processing unit
111 image sensor
112 driving-unit position detecting unit
113 acceleration sensor
114 GPS sensor
115 sound sensor
116 temperature sensor
117 humidity sensor
118 illuminance sensor
119 smoke sensor
120 air sensor
121 ultrasonic sensor
122 microwave sensor
123 laser sensor
124 electric wave sensor
125 infrared sensor
126 touch sensor
127 pressure sensor
128 biological sensor
129 magnetic sensor

### BEST MODE(S) FOR CARRYING OUT THE INVENTION

Preferred embodiments of a traffic information detecting apparatus, a traffic information detecting method, a traffic information detecting program, and a recording medium recording the traffic information detecting program according to the present invention will be described with reference to the accompanying drawings.

### (Functional Configuration of Traffic Information Detecting Apparatus)

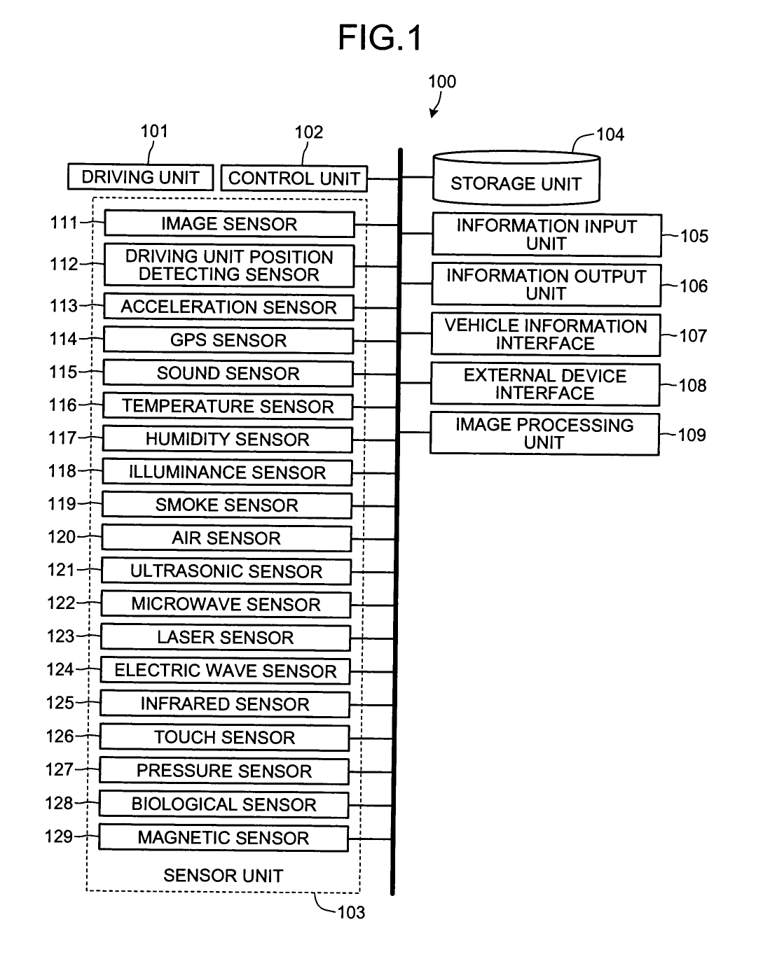

FIG. 1 is a block diagram of a functional configuration of a traffic information detecting apparatus according to an embodiment of the present invention. As depicted in FIG. 1, the traffic information detecting apparatus 100 includes a driving unit 101, a control unit 102, a sensor unit 103, a storage unit 104, an information input unit 105, an information output unit 106, a vehicle information interface (I/F) 107, an external device interface (I/F) 108, and an image processing unit 109.

The driving unit 101 is a driving unit equipped with an image sensor 111 (camera) described hereinafter to drive the camera in the yaw and pitch direction with plural degrees of freedom such as roll directions associated with these directions. The driving unit 101 is disposed at a position where images in front of a vehicle can be captured, such as on the dashboard of the vehicle, near the rear view mirror, on the roof, on the hood, on the front bumper, and on an upper aspect of a side-view mirror. The performance of the camera equipped to the driving unit 101 is assumed to be similar to that of ordinary digital cameras or movie cameras and, for example, the view angles are approximately 40 degrees horizontally and 30 degrees vertically.

The control unit 102 controls the driving unit 101. Specifically, the control unit 102 drives the driving unit 101 and changes the visual field direction of the camera equipped to the driving unit 101 such that the surroundings of the vehicle can be shot extensively.

The sensor unit 103 includes plural sensors and acquires environments inside and outside of a vehicle, position information of the driving unit 101, vehicle position information, etc. Specifically, the sensor unit 103 includes the image sensor 111, a driving-unit position detecting unit 112, an acceleration sensor 113, a GPS sensor 114, a sound sensor 115, a temperature sensor 116, a humidity sensor 117, an illuminance sensor 118, a smoke sensor 119, an air sensor 120, an ultrasonic sensor 121, a microwave sensor 122, a laser sensor 123, an electric wave sensor 124, an infrared sensor 125, a touch sensor 126, a pressure sensor 127, a biological sensor 128, and a magnetic sensor 129.

The image sensor 111 is a sensor, such as a CCD camera, that acquires images. The driving-unit position detecting unit 112 detects a position or rotation of the driving unit 101 through a switch. The acceleration sensor 113 detects, with a gyroscope, etc., acceleration of the vehicle. The GPS sensor 114 detects the current position of the vehicle, based on signals from the GPS satellites. The sound sensor 115 detects the volume of sound and the direction of emission of sound inside or outside the vehicle. The temperature sensor 116 measures the temperature inside or outside the vehicle. The humidity sensor 117 measures the humidity inside or outside the vehicle. The illuminance sensor 118 measures the intensity of light inside or outside the vehicle. The smoke sensor 119 detects smoke inside or outside the vehicle. The air sensor 120 measures components of air. The ultrasonic sensor 121 measures the time until the return of ultrasonic waves emitted from the sensor to measure the distance to an object to be measured. The microwave sensor 122 measures the time until the return of microwaves emitted from the sensor to measure the distance to an object to be measured. The laser sensor 123 measures the time until the return of laser beam emitted from the sensor to measure the distance to an object to be measured. The electric wave sensor 124 measures the time until the return of electric waves emitted from the sensor to measure the distance to the object to be measured. The infrared sensor 125 uses infrared light to acquire image information. The touch sensor 126 determines whether an arbitrary object has come into contact with a target part. The pressure sensor 127 measures the air pressure inside the vehicle and force applied to the sensor. The biological sensor 128 acquires information such as heart rate, brain waves, respiration, etc., of a passenger (such as a driver). The magnetic sensor 129 measures magnetic force.

The storage unit 104 stores various programs driving the traffic information detecting apparatus 100 and various types of information. The information input unit 105 is a user interface for a passenger and includes a keyboard, for example. The information output unit 106 is a user interface for a passenger and includes a display and an LED display device, for example. The vehicle information interface (I/F) 107 inputs/outputs vehicle information such as vehicular speed, a steering angle, and turn indicator information. The external device interface (I/F) 108 inputs/outputs various types of information with respect to external devices such as a car navigation apparatus. The image processing unit 109 executes image processing of the image information acquired by the camera, the image information read from the storage unit 104, and the image information acquired through the vehicle information interface (I/F) 107 and the external device interface (I/F) 108.

The traffic information detecting apparatus 100 detects traffic signals using the camera. Since traffic signals are typically located above roads, the traffic information detecting apparatus 100 must maintain the camera pointing upward to an extent that enables the detection of the vanishing point of a road. When a traffic signal changes to a type of light requiring a stop (such as a red light), the traffic information detecting apparatus 100 tracks and photographs the traffic signal using the camera and, therefore, a larger aspect of the effective resolution of the camera can be used as the resolution for detecting traffic signals by keeping the camera pointing upward with respect to the road vanishing point, which improves the accuracy of traffic signal detection.

### (Processing by Traffic Information Detecting Apparatus)

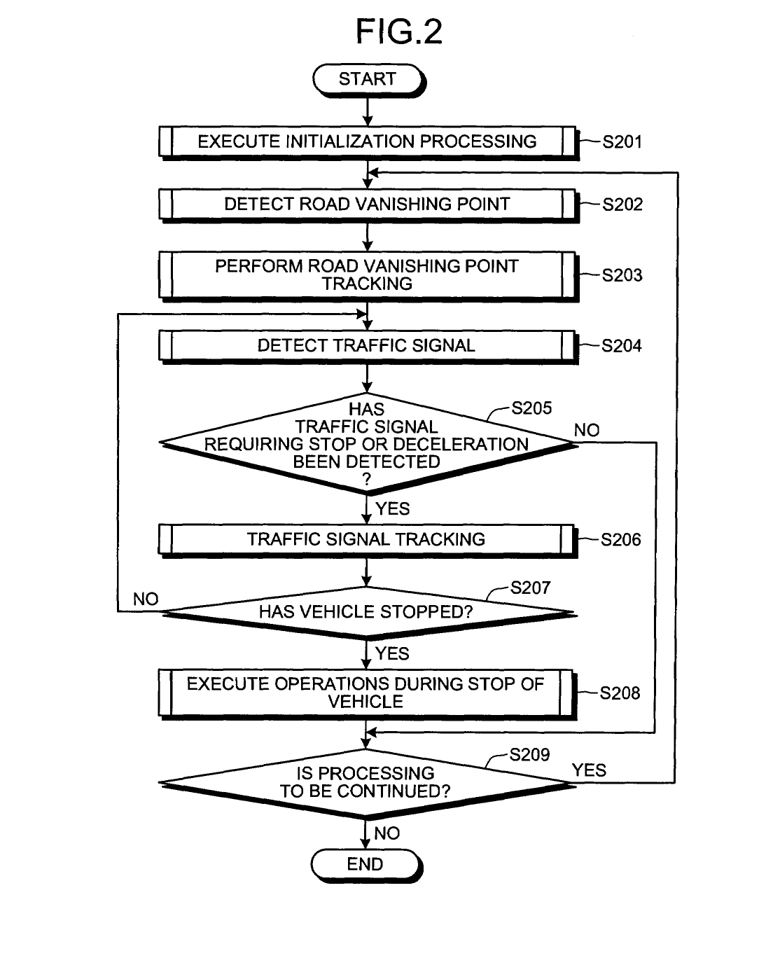

FIG. 2 is a flowchart of an example of processing by the traffic information detecting apparatus according to the embodiment of the present invention. Processing by the traffic information detecting apparatus will be described with reference to the flowchart depicted in FIG. 2.

As depicted in the flowchart of FIG. 2, initialization processing is executed (step S201). The driving-unit position detecting sensor 112 detects the direction of the driving unit 101 equipped with the camera, and the control unit 102 sets a position of the driving unit 101 based on this result such that the camera faces a predetermined direction (initial direction).

The road vanishing point is detected (step S202). Specifically, the camera subjected to the initialization processing shoots the scenery in the direction in which the camera faces, for example, the scenery in front of the vehicle. To detect the road vanishing point, the image processing unit 109 executes predetermined image processing with respect to the captured image of the road being traveled. For example, the road vanishing point is detected by detecting white lines, etc., drawn on the road and calculating a road vanishing point from an extension of the white lines.

The road vanishing point tracking is then performed (step S203). The image processing unit 109 calculates a movement amount for the driving unit 101 equipped with the camera and the control unit 102 drives the driving unit 101 based on the calculated value such that the road vanishing point detected at step S202 can be displayed at a predetermined position in the image of the road.

Detection of a traffic signal is performed (step S204). The image processing unit 109 detects traffic signals in an image area oriented horizontally, above the road vanishing point detected at step S202.

It is determined whether a traffic signal requiring a stop or deceleration has been detected (step S205). This determination is made by the image processing unit 109. A traffic signal requiring a stop or deceleration is a traffic signal illuminating a red light or a yellow light. If a traffic signal requiring a stop or deceleration has not been detected (step S205: NO), the procedure goes to step S209.

On the other hand, if a traffic signal requiring a stop or deceleration has been detected (step S205: YES), traffic signal tracking is performed (step S206). Specifically, the control unit 102 switches the drive mode of the driving unit 101 and performs control so as to monitor a change in the light type of the traffic signal shot by the mounted camera.

It is determined whether the vehicle has stopped (step S207). The acceleration sensor 113 detects acceleration/deceleration of the vehicle, and based on the result, it is determined whether the vehicle has stopped. If the vehicle has not stopped (step S207: NO), the process of step S204 is executed again.

On the other hand, if the vehicle has stopped at step S207 (step S207: YES), operations during stop of the vehicle are performed (step S208). Specifically, the image processing unit 109 detects a change in the light type of the traffic signal from the image of the traffic signal acquired by the camera, displays the change in the light type on the information output unit 106, and informs a passenger when the vehicle can proceed.

It is determined whether the process is to be continued (step S209). This determination is made by a passenger. If the processing is to be continued (step S209: YES), the processing returns to step S202. In such a case the detected light type of the traffic signal indicates a state allowing passage at step S208, and the road vanishing point is newly detected. On the other hand, if the processing is not to be continued (step S209: NO), the processing is terminated. For example, if a passenger determines that the detection of traffic signals by the camera is no longer necessary, the entire process is terminated.

By executing the processing above, the traffic information detecting apparatus according to the embodiment can detect even a traffic signal beyond a blind point of a road such as a sharp bend or a steep slope to acquire accurate light information of the traffic signal. The light information of the traffic signal located close to the vehicle can accurately be acquired.

### EXAMPLE

An example of the present invention will be described. The example describes, in detail, exemplary processing with respect to the flowchart depicted in FIG. 2.

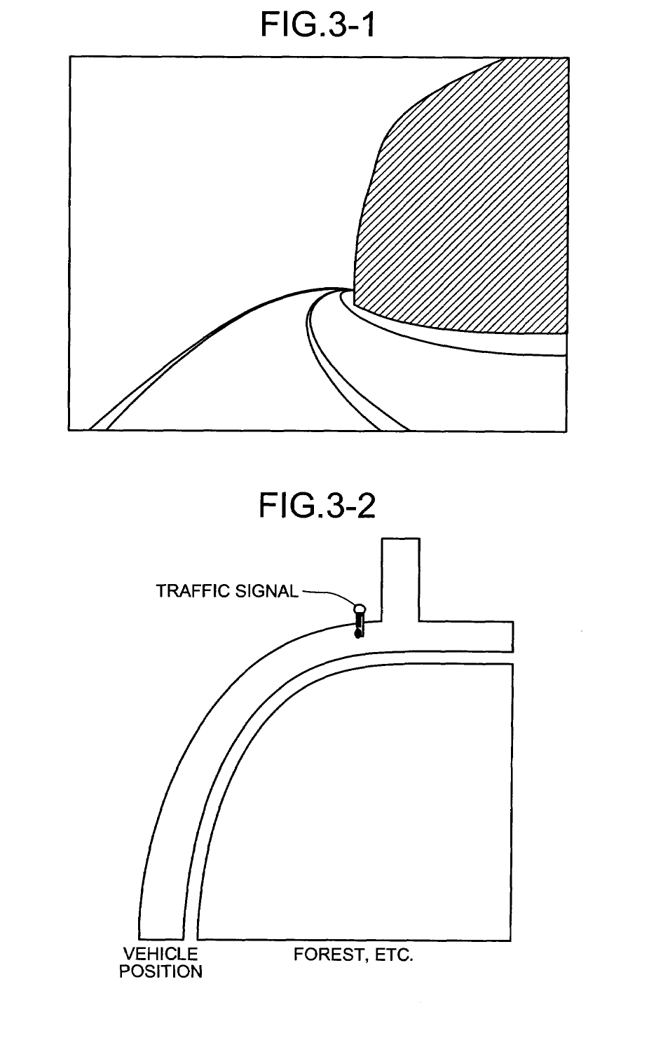

FIGS. 3-1 and 3-2 are diagrams depicting an example of a road condition to be detected. The example describes detection of a traffic signal located beyond a blind, right turn as depicted in FIGS. 3-1 and 3-2.

### (Initialization Processing)

The initialization processing at step S201 of FIG. 2 will be described in detail. In the initialization processing, the driving-unit position detecting sensor 112 detects the direction of the driving unit 101 equipped with the camera, and based on this result, the control unit 102 sets the position of the driving unit 101 such that the shooting direction of the camera is in a horizontal direction ahead of the vehicle.

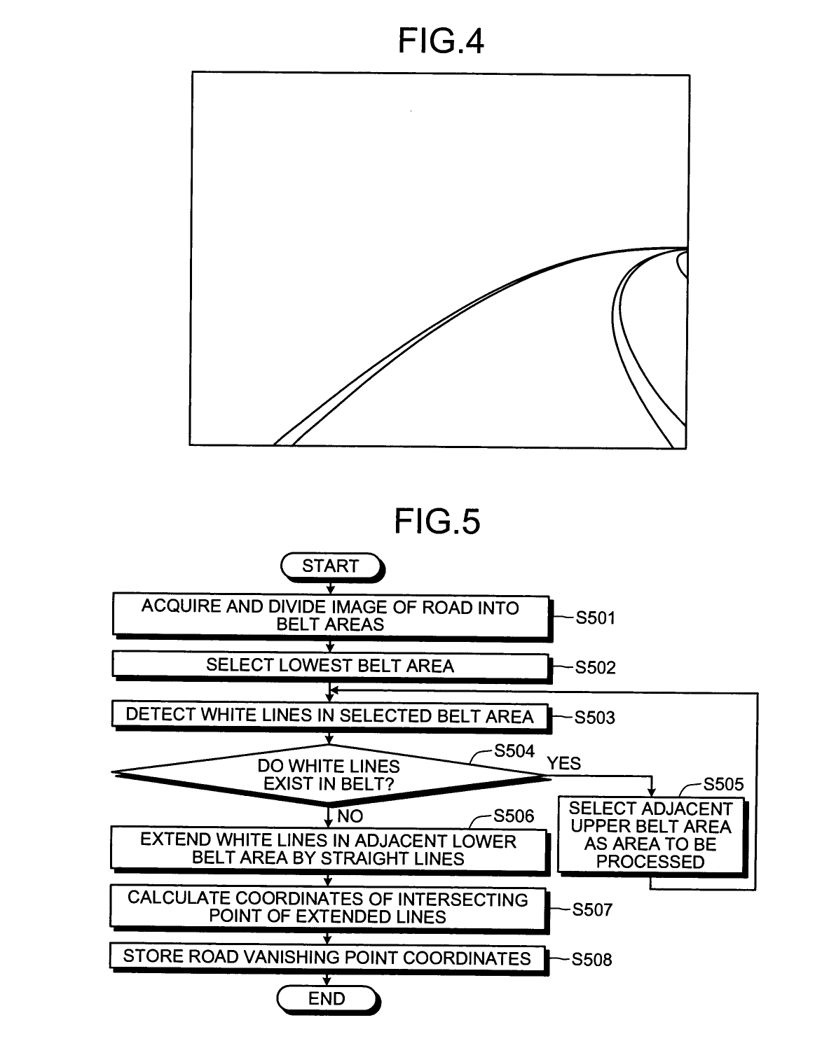

FIG. 4 is a schematic of an exemplary image of a road captured by the camera after the initialization processing. FIG. 4 depicts a photographic image of a forward view captured in the horizontal direction by a camera having a visual field angle of 45 degrees. The resolution of images to be captured is assumed to be a VGA size (640×480 pixels), for example.

### (Road Vanishing Point Detection Processing)

The road vanishing point detection processing at step S202 of FIG. 2 will be described in detail. This processing is executed by the image processing unit 109 with respect to the image of the road captured by the camera as follows.

FIG. 5 is a flowchart of the road vanishing point detection processing. As depicted in the flowchart of FIG. 5, an image of the road being traveled is acquired and divided into belt areas (step S501). Specifically, road scenery in the line of sight of the camera is shot. From the bottom, the captured image of the road is divided into belt-shaped areas of a certain height (e.g., 40 pixels).

The lowest belt area is selected (step S502). White line detection is performed in the selected belt area (step S503). The white lines are center lines, etc., drawn on the road. It is determined whether white lines exist in the belt (step S504). If white lines are detected in the belt (step S504: YES), the adjacent upper belt area is selected as an area to be processed (step S505), and the processing returns to step S503.

If no white line(s) is detected in the belt at step S504 (step S504: NO), white lines in the adjacent lower belt area are extended by straight lines (step S506). Specifically, each of right and left white lines in the belt area is subjected to collinear approximation and is extended by a straight line. Coordinates of the intersecting point of the extended lines are calculated (step S507). Lastly, the road vanishing point coordinates are stored (step S508). Specifically, the coordinates of the intersecting point calculated at step S507 are saved in the storage unit 104 as the road vanishing point coordinates.

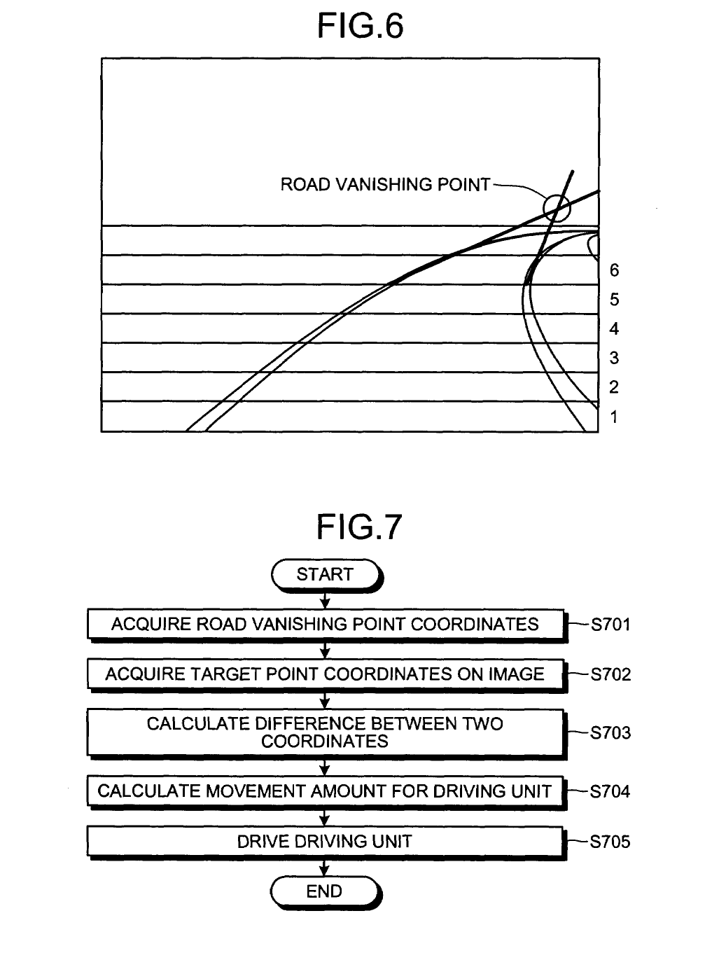

FIG. 6 is a diagram for explaining the calculation of the road vanishing point coordinates. As depicted in FIG. 6, white lines are detected in ascending order of the belt area numbers and the road vanishing point detection processing is executed for the uppermost area with the white lines detected.

### (Processing for Tracking the Road Vanishing Point)

The processing for tracking the road vanishing point at step S203 of FIG. 2 will be described in detail. In this processing, the image processing unit 109 calculates a movement amount of the driving unit 101 equipped with the camera and the control unit 102 drives the driving unit 101 based on the calculated value such that the road vanishing point detected at step S202 can be displayed at a predetermined position in the image.

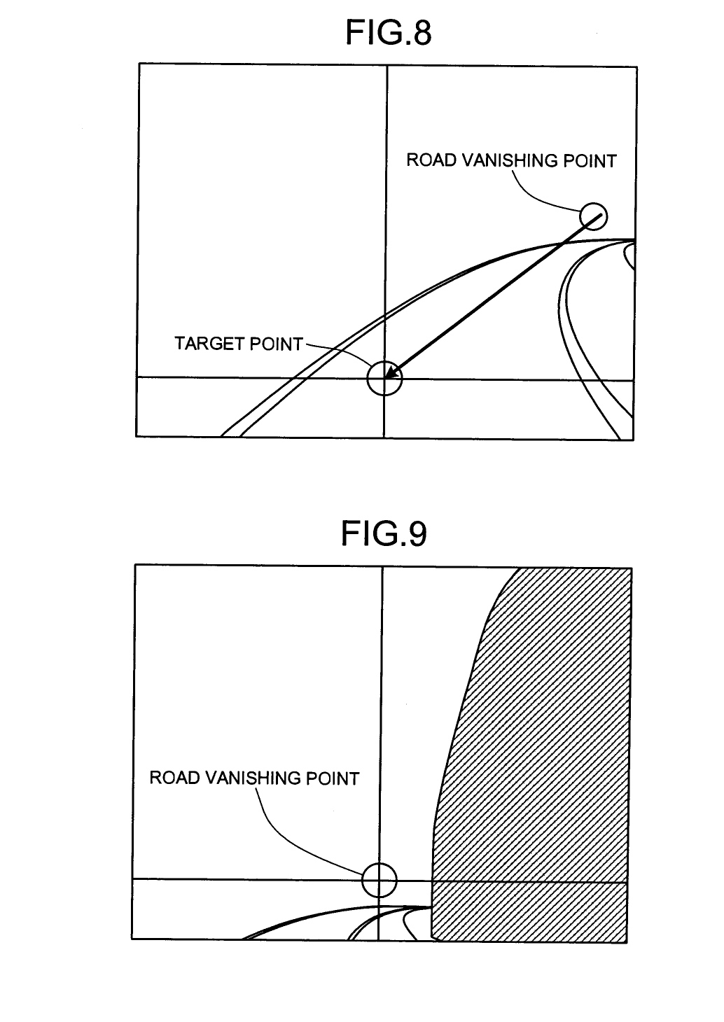

FIG. 7 is a flowchart of the processing for tracking the road vanishing point. FIG. 8 is a diagram for explaining the processing for tracking the road vanishing point. FIG. 9 is an image diagram of the image of the road after the processing for tracking the road vanishing point.

As depicted in the flowchart of FIG. 7, the road vanishing point coordinates are acquired (step S701). The values of the road vanishing point coordinates calculated by the above road vanishing point detection processing are read from the storage unit 104.

Target point coordinates on the image are acquired (step S702). First, the driving unit 101 is driven such that the road vanishing point is detected at a certain position on a screen. Specifically, the driving unit 101 equipped with the camera is driven such that white lines can be detected in the lowest belt area by the above road vanishing point detection processing and such that the road vanishing point is detected at a position on the lower side of the image. For example, as depicted in FIG. 8, the certain position is located at a position (target position) substantially equidistance from the left and the right sides of the image, 80 pixels away from the bottom. This driving enables tracking to be performed such that the road vanishing point is located on the lower side of the image, thereby enabling the area located above the road vanishing point in the image to be defined as a traffic signal detection area and further enabling the traffic signal detection area to always be maximized. Since images of the area above the road in the traveling direction where traffic signals are most likely to be detected can be continuously be captured, the accuracy of the traffic signal detection is further improved. Since the camera can be driven to track such that the road vanishing point is detected on the lower side of the image even on a road having a sharp bend or a steep slope, the accuracy of the traffic signal detection can be increased regardless of the road shape. Such processing for tracking the road vanishing point enables the driving of the camera for tracking to achieve the composition as depicted in FIG. 8 regardless of the road shape.

A difference between two coordinates is then calculated (step S703). Differences are obtained between the coordinates of the road vanishing point and the coordinates of the target position in the image. For example, pixels between two points having the coordinates of the road vanishing point and the coordinates of the target position of FIG. 8 may be calculated to be 280 pixels in the horizontal direction and 210 pixels in the vertical direction.

A movement amount of the driving unit 101 is then calculated (step S704). A conversion process is executed from the differences calculated at step S703 into a drive angle of the driving unit 101. Specifically, the view angle and the resolution of the camera are used for approximately conversion of the differences into the drive angle. For example, in the exemplary case depicted in FIG. 8, the driving unit 101 is moved 280 pixels in the horizontal direction and 210 pixels in the vertical direction. Assuming that the camera has view angles of 45 degrees horizontally and 40 degrees vertically, and a resolution of 640 horizontal pixels and 480 vertical pixels, the horizontal drive degree and the vertical drive degree to displace the road vanishing point to the target point can be represented by the equations 1 and 2, respectively.

280×45/640=19.69 (1)

210×40/480=17.5 (2)

Lastly, the driving unit 101 is driven (step S705). The driving unit 101 is driven based on the calculated values at step S704. For example, the driving unit 101 is rotated by 19.69 degrees in the yaw direction and 17.5 degrees in the pitch direction according to the values obtained from equations 1 and 2.

### (Traffic Signal Detection Processing)

The traffic signal detection processing at step S204 of FIG. 2 will be described in detail. In this processing, the image processing unit 109 detects a traffic signal in an image area oriented horizontally, above the road vanishing point captured by the above processing for tracking the road vanishing point.

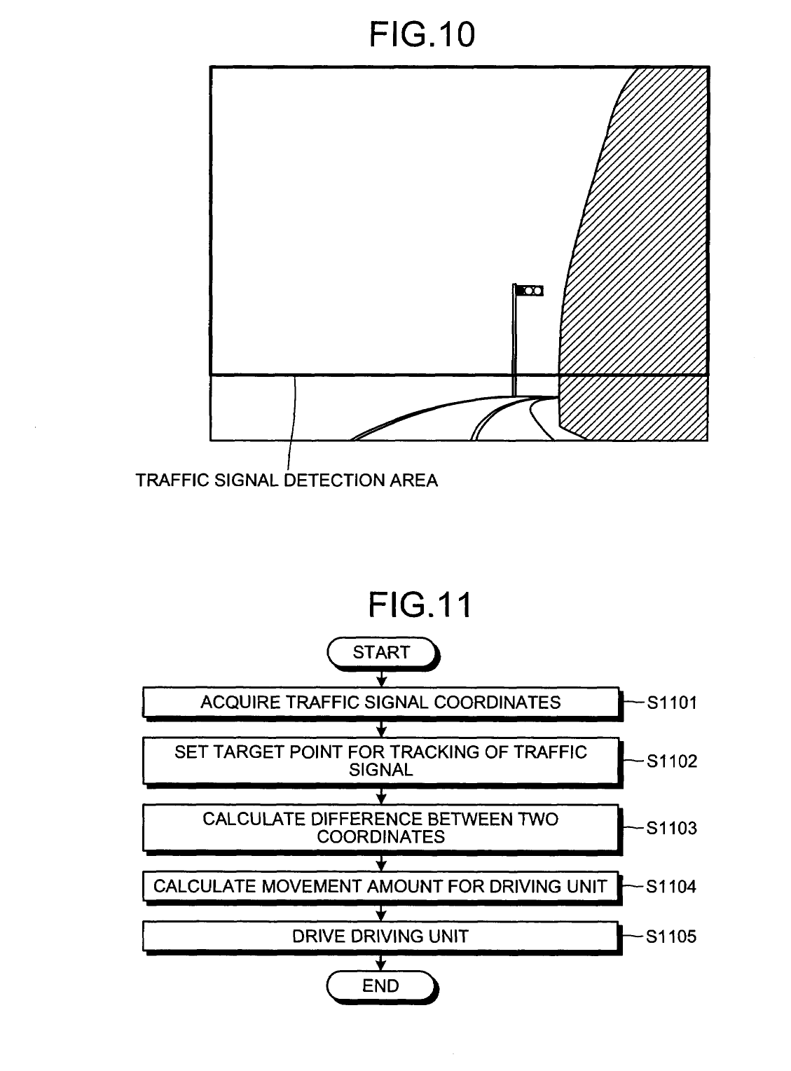

FIG. 10 is a diagram of a traffic signal detection area. With the camera pointed in the direction of the road vanishing point according to the above processing for tracking the road vanishing point, a traffic signal is likely to be detected above the position of the road vanishing point. Therefore, the image area located above the road vanishing point is defined as a traffic signal detection area to maximize the accuracy of initial detection of a traffic signal.

A traffic signal is detected in the traffic signal detection area with the use of a known traffic signal detection algorithm. The coordinates of the center of the illuminated light, the vertical and horizontal lengths, and the light type information of the detected signal are stored in the storage unit 104.

The method of tracking by the driving unit 101 equipped with the camera is switched according to the determination result of the traffic signal light type. For example, if the detected signal requires the vehicle to stop or decelerate as in the case of a red light or a yellow light, the method is switched to traffic signal tracking processing. If a signal allowing passage such as green signal is illuminated, processing for tracking the road vanishing point is continued.

### (Traffic Signal Tracking Processing)

The processing for tracking a traffic signal at step S206 of FIG. 2 will be described in detail. The processing for tracking a traffic signal is executed if a traffic signal requiring a stop or deceleration is detected at step S205 of FIG. 2. The control unit 102 switches the drive mode of the driving unit 101 and performs control so as to capture a change in the light type of the traffic signal with the mounted camera.

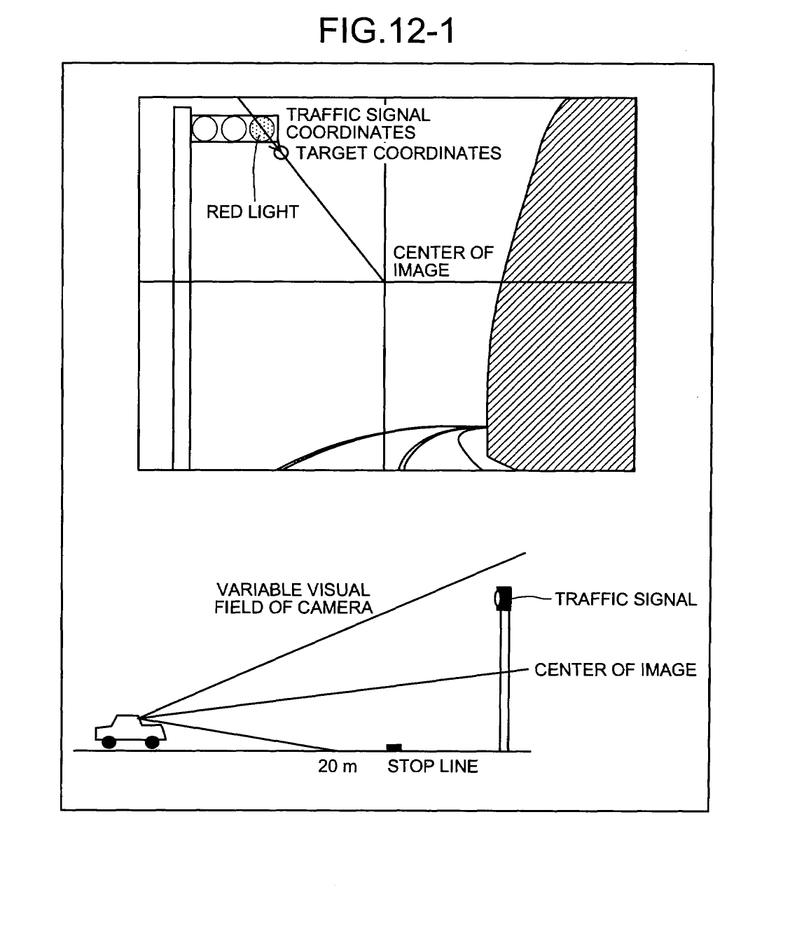

FIG. 11 is a flowchart of the processing for tracking a traffic signal. As depicted in the flowchart of FIG. 11, the traffic signal coordinates are acquired (step S1101). The traffic signal coordinates stored by the above traffic signal detection processing are read from the storage unit 104.

A target point for tracking the traffic signal is set (step S1102). A straight line is drawn from the center coordinates of the image captured by the camera and passes through the traffic signal coordinates; and the tracking target point is set to a certain point between the center coordinates of the image and an intersecting point of the straight line and the edge of the image. For example, a line from the center of the image to the edge of the image is divided into four and the tracking target point is set such that the traffic signal comes to a third segment from the center. This enables the driving unit 101 to be driven such that the traffic signal is detected at the tracking target point and, as a result, the tracking by the camera may be performed such that the signal does not go out of the image.

A difference between two sets of coordinates is then calculated (step S1103). Differences are obtained between the coordinates of the traffic signal and the coordinates of the target point. A movement amount of the driving unit 101 is then calculated (step S1104). Although the drive angle of the driving unit 101 is calculated with the use of the calculation result at step S1103, this method is similar to the method described with respect to the above processing for tracking the road vanishing point. Lastly, the driving unit 101 is driven (step S1105). The driving unit 101 is driven based on the calculated result at step S1104. The processing for tracking a traffic signal will be described with reference to FIGS. 12-1 and 12-2.

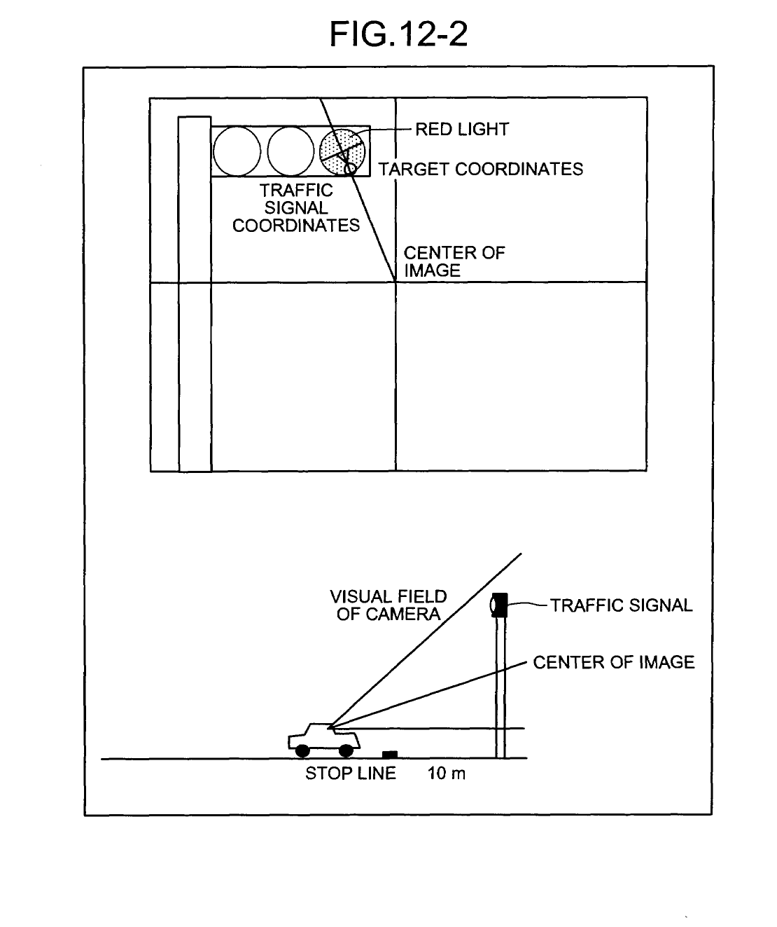

FIGS. 12-1 and 12-2 are diagrams for explaining the traffic signal tracking processing. As depicted in FIG. 12-1, if a red light is detected, the tracking target point is set according to the above technique and the driving unit 101 is driven such that the camera faces in the direction of the target point. When the vehicle subsequently moves forward and an image of the traffic signal is captured, the size of the traffic signal in the image is larger as depicted in FIG. 12-2. The target point is calculated and the driving unit 101 is driven as described above in this case. When the vehicle comes closer to the traffic signal, the road may not be captured in the image and only the traffic signal located on the upper side may be captured in some cases. The coordinates of the center of the illuminated light, the vertical and horizontal lengths, and the light type information of the traffic signal detected by the traffic signal tracking processing are stored in the storage unit 104.

During the processing for tracking the traffic signal, a vehicle speed is detected from the vehicle information and if it is detected that the vehicle is stopped or moves within a certain speed (e.g., 10 km/h), the following operations during stop of the vehicle are performed.

### (Operations During Stop of Vehicle)

The operations during stop of the vehicle will be described in detail. The operations during stop of vehicle involve the image processing unit 109 detecting a change in the light type of the traffic signal from the image of the traffic signal acquired by the camera, displaying the change on the information output unit 106, and informing a passenger when the vehicle can be proceed.

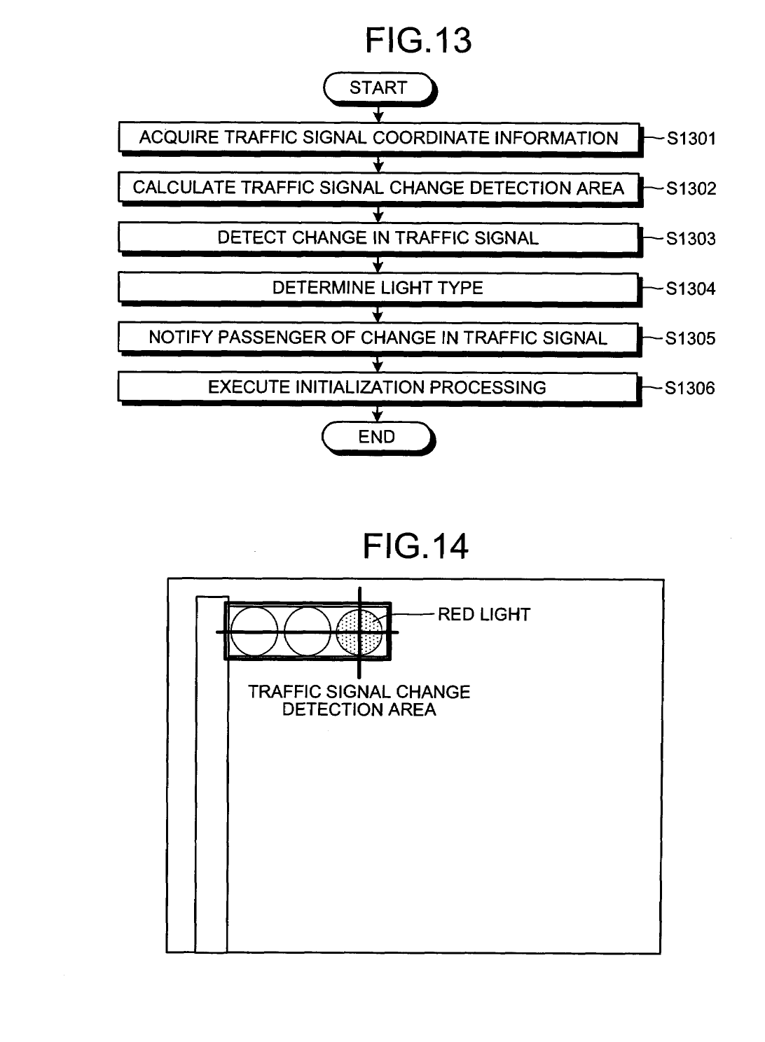

FIG. 13 is a flowchart of the operations during stop of the vehicle. As depicted in the flowchart of FIG. 13, traffic signal coordinate information is acquired (step S1301). The coordinates of the illuminated signal center, the vertical and the horizontal lengths, and the light type information of the traffic signal detected in the processing for tracking a traffic signal are read from the storage unit 104.

A traffic signal change detection area is calculated (step S1302). The traffic signal change detection area is calculated based on the traffic signal coordinate information acquired at step S1301. A technique of calculating the traffic signal change detection area will be described hereinafter with reference to FIG. 14.

FIG. 14 is a diagram for explaining a technique of calculating the traffic signal change detection area. As depicted in FIG. 14, the light type information indicates a red light and a rightmost one of three light devices is illuminated, where the traffic signal change detection area is defined as an area having a height equivalent to the vertical length of the illuminated light and a length extending horizontally to the left three times longer than the illuminated light. If non-illuminated lights in this area are detected as circles having a size equivalent to an illuminated light, this area is determined as a correct area for the traffic signal change detection area, and a change in the traffic signal is detected as described hereinafter. If multiple circles are not detected in the area, the traffic signal may be a vertical traffic signal in snow countries or an auxiliary signal for blind points and, therefore, if the illuminated light is a red light, the traffic signal change detection area is defined as an area having a width in the horizontal direction equivalent to the horizontal width of the illuminated light and a vertical length extending downward three times longer than the illuminated light.

According to another technique, circles of a size equivalent to that of the illuminated light may be detected around the traffic signal to detect a green light, a yellow light, an arrow signal, etc., at the same time, and the traffic signal change detection area may be defined as a rectangular area including the areas where the circles are detected.

A change in the traffic signal is detected (step S1303). Once an image of the traffic signal change detection area calculated at step S1302 is stored in the storage unit 104, a change in the traffic signal is detected by comparing the stored image with an image of the traffic signal change detection area calculated based on an image subsequently captured. For example, a difference between two images may be obtained to detect a change in the traffic signal.

The light type is determined (step S1304). The type of light is determined with the use of a conventional technology. If the signal changes to a signal allowing passage such as a green light, a passenger is notified of the change in the traffic signal (step S1305). In this case, a passenger is notified that the traffic signal has changed to a signal allowing passage. Notification may be made via the display on the information output unit 106, a driving of the driving unit 101, etc., i.e., any means that causes a passenger to realize the change in the traffic signal.

Lastly, the initialization processing is executed (step S1306). The monitoring of the traffic signal is terminated and the driving unit 101 is driven to turn the camera to the horizontal direction ahead of the vehicle to start the traffic signal detection during normal travel.

By executing the processing described above in sequence, even a traffic signal after a blind point of a road such as a sharp bend or a steep slope can be detected accurately and the light information of the traffic signal can be acquired under normal circumstances. However, the traffic signal detection and the tracking and photographing of the traffic signal after the detection may fail for some reason. Such a case may be compensated by executing the following techniques.

### (Case of Failing to Detect or Follow Traffic Signal Due to Preceding Vehicle)

In such a case that a traffic signal is hidden behind the preceding vehicle during tracking, the camera detects a traffic signal of the intersection in the direction of the opposite lane. If a traffic signal is detected, the switch-over to the operations during stop of the vehicle is executed. Since the degree of reliability is reduced in this case because the traffic signal is different from the traffic signal that should be followed, the passenger may be notified by a display of the detected traffic signal on the information output unit 106, for example. If a traffic signal of the intersection does not exist above the opposite lane, etc., a brake lamp of the preceding vehicle is detected to notify a change in the brake lamp. A vehicle width of the preceding vehicle and a distance to the preceding vehicle may be detected to make a notification if the preceding vehicle has proceeded forward.

### (Processing When Traffic Signal is Too Close)

If it is prescribed that a lighting unit of a traffic signal is determined when a circle image is detected, the traffic signal may not be detected since the lighting unit of the traffic signal may be captured as an oval image if the traffic signal is too close. In such a case, without performing the circle judging processing, color information, etc., may be used for the detection based on a prediction using the traffic signal position detected in the previous frame by the algorithm used for the traffic signal tracking.

Two or more traffic signals may exist in a large intersection. Therefore, when a second traffic signal can be detected, if a first traffic signal is too close, the second traffic signal may be used as the signal to be followed. However, this is effective only when the signals are determined to be present at the same intersection. For example, if it is determined that a light type of a traffic signal is different or the size is obviously different, it is further determined that the traffic signal is remotely located and this technique is not performed.

### (Processing When Reliability of Traffic Signal Detection Result is Low)

If a score is given to the accuracy of the traffic signal detection and if the tracking is performed when the traffic signal detection score is not greater than a certain value, for example, when the score is not greater than 50 out of 100, the reliability of the traffic signal detection accuracy is reduced. Therefore, if the traffic signal detection score is not greater than a certain value, the tracking is terminated. Alternatively, when the traffic signal detection score is reduced similarly in the operation during stop, if the detection of a change in the traffic signal is continuously performed, a passenger may be notified of a wrong detection result. Therefore, if the traffic signal detection score is not greater than a certain value, the direction of the camera may be deviated from the direction of the traffic signal to notify the passenger that the detection failed. In such a case, for example, if the camera is turned to the inside of the vehicle, the passenger may recognize that the detection of the traffic signal was not achieved.

### (Processing When Multiple Traffic Signals are Detected)

Multiple traffic signals may be detected when the view angle of the camera or the direction of the camera is changed. In such a case, which traffic signal should be followed or monitored for detecting a change must be determined frequently. Especially, while traveling on a straight road, traffic signals located at multiple intersections ahead may concurrently be detected. In this case, the traffic signals located at intersections are classified based on the positions of the traffic signals and the sizes of the illuminated lights to cluster the traffic signals according to intersection. The clustered traffic signal groups are sequentially detected from the nearest intersection and the light type of the traffic signal is determined to switch the processing for tracking the road vanishing point and the processing for tracking a traffic signal described above.

If multiple traffic signals are detected at the time of the operations during stop of the vehicle, the directions of the traffic signals are represented by camera drive angles and traffic signal coordinates, which are recorded in the storage unit 104. A passenger is suggested to select a traffic signal for detecting a change. In this case, for example, the information output unit 106, etc., may display numbers or directions of candidate traffic signals or display a camera image of the candidate traffic signals to perform the marking of the detected traffic signals. This enables a passenger to select a necessary traffic signal. Alternatively, the traffic signals may be prioritized in the order from a traffic signal located on the upper side in front of the vehicle, may be numbered in ascending order from the nearest to the farthest, and may be displayed or automatically be switched in the order of the numbers. If a passenger selects a traffic signal while the traffic signals are automatically switched, the automatic switch mode may be terminated to execute the above operations during stop of the vehicle.

### (Processing When Passenger Wants to Specify Direction in Which Traffic Signal is to be Detected)

A traffic signal may not be detected at some intersections while the vehicle is stopped. In such a case, a passenger may be allowed to arbitrarily set the direction of the camera. However, in this case, it is difficult to perform a large amount of operations in a short period of time during interruption of the driving. Therefore, if a passenger wants to specify the direction of the traffic signal to be detected, automatic setting may be enabled by the passenger by pressing only one particular button. For example, when the passenger presses a predetermined button, first, the camera is turned to the inside of the vehicle to detect the direction of the line of sight of the driver. The direction of the passenger's line of sight toward the outside of the vehicle is recognized from the relative positions of the direction of the line of sight and the camera and the camera is turned to the direction. A traffic signal in the direction is set as the traffic signal the passenger wants to detect.

### (Processing When Traffic Signal is Overlooked)

After a red light is detected and the switch-over to the processing for tracking a traffic signal is performed, if the vehicle passes through the intersection without stop before it is determined that the traffic signal is green allowing the passage, it is determined that the traffic signal has been overlooked and a video is recorded for a certain time before and after the passage as a moving image or a series of images, and the passenger is notified. The passenger is notified by a warning sound, voice, light, rotation, vibrations, etc.

### (Detection Processing for Residual Vehicle, etc.)

If the vehicle is at the head of a queue of vehicles waiting for the light to change while stopping at an intersection and the traffic signal changes to a signal allowing passage such as a green light, a visual check for vehicles traveling on the intersecting road and crossing pedestrians must be performed. However, there may occasions when the visual check may fail. Therefore, immediately after the signal changes to green, the appearances of the intersecting road and the crosswalks are monitored by horizontally driving the camera. If a vehicle or pedestrian may intrude into the path of travel, a passenger is notified by a warning sound, voice, light, rotation, vibrations, etc.

### (Processing When Unable to Detect Road Vanishing Point)

If a road shape is unusual or a preceding vehicle is a large vehicle, the white lines on the road may not be detected and the road vanishing point may not be recognized. Particularly, when a road has a steep slope shape and, especially, at a point immediately before a downward slope, the white lines extend downward under the vehicle and may go down and out of the image range. In this case, the camera may be turned in the horizontal and vertical directions to photograph a wider road area.

Since some roads have no white line drawn and the white line detection may not be performed, the road vanishing point may not be detected. In this case, the road vanishing point is calculated from another known technology. For example, line components in the surroundings are calculated and the direction of a drawn white line is defined as a direction of the largest number of lines concentrating and intersecting when the line components are extended.

If the road vanishing point cannot be detected due to a preceding vehicle, processing to track the preceding vehicle tracking may be enabled at the same time with the road vanishing point detection processing. For example, since the direction of the road vanishing point is the direction of the number plate of the preceding vehicle or the center of the preceding vehicle, the number plate of the preceding vehicle or the center-of-mass direction of the preceding vehicle viewed from the back is detected and the camera follows the direction thereof. The traffic signal detection area is defined in an area other than the vicinity of the vehicle determined as the preceding vehicle. If a large preceding vehicle is present at the time of stop, the traffic signal detection is performed avoiding the vicinity of the vehicle determined as the preceding vehicle.

### (Processing When Blinking of Traffic Signal is Detected)

The light may flash at certain intervals or the light may be turned off at moments on some traffic signals. If the traffic signal tracking is performed for an image taken when these traffic signals are not lighted, the traffic signals may not be tracked. In such a case, the coordinates of the detected signal and the camera direction information and other vehicle information at the time of the detection are stored in the storage unit 104 as needed, and a position of the traffic signals may be predicted from several images acquired in the past to perform tracking without interruption.

### (Processing When Traffic Signal Detection is Not Performed During Travel)

For example, in some cases, it is desired that the camera is turned in every direction inside or outside the vehicle to execute other processing during travel and that the detection is performed at the time of stop only when the traffic signal changes from red to green in the operation during stop. However, it is problematic that the direction of the traffic signal detection may not be identified after stop. Therefore, in such a case, deceleration of the vehicle may be detected from the information acquired by the acceleration sensor 113, such as vehicle speed pulse information, and if the deceleration is detected, the camera may be turned forward to perform the processing for tracking a traffic signal until the vehicle stops.

### (Other Processing for Tracking in Bend Direction)

On a sharp bend, it may be difficult to bring white lines or a road area into sight and the road vanishing point may not be detected properly. Therefore, the acceleration sensor 113 having a lateral acceleration detecting function may be included to detect lateral acceleration of the vehicle on a sharp bend and an appropriate shooting direction may be calculated from the lateral acceleration and the speed of the vehicle to drive the driving unit 101 such that the camera is turned to the direction. This enables the traffic signal detection accuracy to be increased even when the road vanishing point cannot be detected.

### (Processing When Detecting Object Other Than Traffic Signal)

The present invention enables detection of objects other than traffic signals. For example, road guidance displaying signs for an intersection guide may be detected. Since the signs may be detected in the same way as traffic signals, the detection may be accommodated by executing the processing for tracking the road vanishing point described above. If a sign is detected, a high-resolution image maybe taken by tracking the sign to acquire an image at close range and, therefore, the application to the traffic guide displaying signs is available through character recognition, etc. Lighting units of crossings of railways, for example, red blinking lights or arrow lights may be detected and utilized for guidance.

### (Variation of Traffic Signal Tracking Direction)

When detecting a traffic signal light requiring a stop and causing the switch-over to the processing for tracking a traffic signal, the lighting unit of the traffic signal may be brought to the center of the image.

### (Variation of Processing for Tracking a Traffic Signal)

Driving of the driving unit 101 may be switched depending on whether a traffic signal is detected. For example, the tracking of the road vanishing point is performed at the time of the normal travel, and the switch-over to the traffic signal tracking is caused when a traffic signal is detected in the traffic signal detection area. If the traffic signal cannot be tracked within the view angles of images captured within a range of the operational angle of the camera, the camera is initialized to execute normal processing for the tracking of the road vanishing point.

### (Correction in Roll Direction)

A vehicle may tilt in the roll direction due to centrifugal force on a bend, etc. If the road image captured in this case is considerably tilted, trouble may occur in the road vanishing point detection based on the white line detection, etc. If the traffic signal detection area is defined as an area above the road vanishing point, a traffic signal cannot be captured in the traffic signal detection area due to the tilt in the roll direction and may not be detected appropriately. In such a case, the shape of the bend ahead on the road, a steering angle acquired through the acceleration sensor 113 or the vehicle information interface (I/F) 107, etc., are detected, and the camera is driven to track the direction base on this information such that the acquired road image is kept horizontal. This improves the traffic signal detection accuracy.

### (Process of Acquiring Information Around Traffic Signal)

Character information around a traffic signal may be recognized as characters or symbols by the image processing unit 109. In this case, when the camera tracks a traffic signal, image processing is executed for the image area around the traffic signal coordinates. For example, the image processing unit 109 executes a process using the OCR technology, the template matching technology, etc. If an intersection name, an auxiliary signal, etc., can be acquired as a result of detection, the result may be utilized in various applications. For example, the right/left turn guide information for the intersection, etc., may be acquired with the use of an intersection name in conjunction with navigation information.

### (Auxiliary Signal Detection Processing)

If a traffic signal exists after a sharp bend or a blind point on the road, an auxiliary signal may exist at a certain distance before such a point on the road. In such a case, the above processing of acquiring information around a traffic signal is executed to acquire character information around the traffic signal. If a character string representative of the presence of an auxiliary signal can be acquired, the processing for tracking a traffic signal is not executed and the actual traffic signal is preferentially detected since the traffic signal actually exists ahead.

### (Traffic Signal Point Registration Processing)

According to the present invention, traffic signal position information can be collected. Since fixed cameras must generally detect a faraway traffic signal and separately calculate a distance to the point, the process becomes complicated and the accuracy is reduced. In the case of wide-angle cameras, it is difficult to obtain resolution that enables highly accurate traffic signal detection. Therefore, highly accurate traffic signal position information can be acquired by using the method of the present invention.

For example, the GPS sensor 114 is used to acquire position information of a point of a detected traffic signal from the GPS satellites and the GPS coordinates of the traffic signal detection point are stored in the storage unit 104. The initial detection accuracy of the traffic signal is improved by the processing for tracking the road vanishing point; the traffic signal is tracked in the above process described in another example of the processing for tracking a traffic signal to determine when approaching closest to the traffic signal; and the GPS coordinates of the point are defined as the signal position. The approach determination may be made for a point having certain values, or more, for a lighting unit size of the traffic signal and an angle of the camera in the pitch direction. For example, the point is determined when the angle is 60 degrees or more in the pitch direction and the diameter of the circle portion of the traffic signal occupies 30 pixels or more in the resolution of the camera.

### (Variation of Operation During Stop of Vehicle)

The surroundings of the detected signal are defined as the image processing area in the above operations during stop of the vehicle. However, in this case, an area three times larger than the lighting unit size must be subjected to the image processing even while the traffic signal does not change. Therefore, a change in coordinates of the detected traffic signal may be monitored and only when the detected traffic signal area is changed, a search range may be extended to that of the traffic signal change detection area. If a new traffic signal cannot be detected in this case, the traffic signal detection may be performed for the entire traffic signal change detection area in the above operations during stop of the vehicle. It may be determined that a change occurs if the light type is different as compared to the already detected traffic signal information.

### (Appearance of Camera)

When the information output unit 106 (such as a monitor screen) displays an image of the camera, especially, an enlarged image, it may not be known from which direction the image has been captured in some case. Therefore, it is preferable to design the camera in such a shape that the shooting direction of the camera may intuitively be understood from the appearance of the camera. For example, a shape imitating a robot or an animal facilitating the understanding of the shooting direction of the camera tends to allow a passenger to intuitively know the shooting direction of the camera. This enables the passenger to easily understand the shooting direction of the camera and to recognize false operations such as monitoring an object other than the traffic signal that should be monitored. A sense of security may also be acquired since a robot in the friendly shape is monitoring. The apparatus may be provided as a partner robot that monitors traffic signals during traveling or a stop.

### (Variation of Timing of Switching Drive Method)

The switch-over to the processing for tracking a traffic signal is executed in the above example when the light of the traffic signal requiring a stop or deceleration is detected. However, if a traffic signal turns to yellow when the traveling speed of the vehicle is a certain value (e.g., 60 km/h) or more and the traffic signal is located at a short distance, it may be safer to swiftly pass the traffic signal than stop the vehicle. In such a case, the switch-over to the processing for tracking a traffic signal is not executed and the processing for tracking the road vanishing point is continued to give priority to the detection of the next traffic signal.

### (Variation of Processing for Tracking the Road Vanishing Point)

Although the traffic signal detection area is set larger by tracking the road vanishing point on the lower side in the present invention, depending on circumstances, the road vanishing point may be brought to an arbitrary position in the screen when being tracked. For example, if the preceding vehicle is a large vehicle and the vehicle travels on a wide road having multiple traffic signals at each intersection and traffic signals on the side of the opposite lane, the camera is driven to follow the opposite lane direction instead of the preceding vehicle direction.

### (Example of Detecting Traffic Information Displaying Device Other Than Traffic Signal)

For example, a traffic guide signboard (a blue signboard guiding destinations in an intersection) is detected. If a traffic guide signboard is detected in the distance, the character information cannot be read in the distance due to the resolution. Upon coming closer to the signboard, the signboard may go out of the visual field of the camera. Therefore, the traffic guide signboard is tracked in the same way as the processing for tracking a traffic signal described above. If the camera directed toward the front detects a blue signboard and the signboard is determined as a traffic guide signboard, tracking of the signboard is performed. When the signboard becomes closer and enters into a range where detailed information such as character information can be acquired from a camera image, the image is stored in the storage unit 104 and the image processing unit 109 uses the OCR function to read information written on the signboard, for example, place name information of the destinations of the roads in the intersection. If the signboard information can be acquired, the method is shifted to the normal camera driving method. For example, the camera is turned toward the front. Alternatively, the processing for tracking the road vanishing point is executed.

### (Variation of Signal Tracking Processing)

Although the processing for tracking a traffic signal is executed when the traffic signal requiring a stop or deceleration is detected in the present invention, the processing for tracking a traffic signal may also be executed when detecting any lights of the traffic signals such as a green light. For example, the camera is horizontally fixed toward the front during the normal traveling and if some information is acquired, tracking is performed. In this case, if a traffic signal is detected, tracking is performed for the traffic signal and if a signboard, etc., is detected, tracking is performed for the signboard. Specifically, the image processing unit 109 determines the necessity of tracking, and if it is determined that tracking is necessary, tracking is performed.

### (Example of Executing Image Processing Outside the Apparatus)

The traffic information detecting apparatus 100 of the present invention includes the vehicle information interface (I/F) 107 and the external device interface (I/F) 108. The vehicle information interface (I/F) 107 is connected to an ECU of the automobile and through the ECU to an external image processing apparatus or a computer. The external device interface (I/F) 108 is connectable to a car navigation apparatus, a computer, and any devices housing an image processing unit. The external device interface (I/F) 108 may be connected to a network device, a communication device, a portable telephone, etc., as an external device to transmit/receive information to/from a server. The interface specification may be a general-purpose specification such as USB, Ethernet (registered trademark), and wireless communication or may be an external bus or a special specification.

The vehicle information interface (I/F) 107 and the external device interface (I/F) 108 are used to transmit/receive image information to execute the image processing in the vehicle or an external apparatus. The result of the image process, the presence of a traffic signal or signboard, and other pieces of detected information are received through the vehicle information interface (I/F) 107 or the external device interface (I/F) 108 to control the camera.

As described above, according to the present invention, the camera may be driven to follow the direction that maximizes the traffic signal detection area by detecting the road vanishing point. If the light of a traffic signal requiring a stop is detected, the switch-over to the processing for tracking a traffic signal is performed. By executing such a process, even a traffic signal beyond a blind point of a road such as a sharp bend or a steep slope can be detected with certainty to acquire accurate light information concerning the traffic signal. The light information of the traffic signal located close to the vehicle can also be acquired accurately. By executing the various processing above, the detection accuracy can be improved for objects to be detected including the light information of traffic signals.

The traffic information detecting method explained in the present embodiment can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be a transmission medium that can be distributed through a network such as the Internet.

1-13. (canceled)

14. A traffic information detecting apparatus comprising:
a camera;
a driving unit that is equipped with the camera and defines a shooting direction of the camera;
an image processing unit that executes predetermined processing with respect to an image of a traffic signal captured by the camera and detects a state of the traffic signal; and
a control unit that drives the driving unit based on a detection result of the image processing unit, wherein
the image processing unit recognizes a light type of the traffic signal from an image of a road along which a vehicle is traveling, the image of the road being captured by the camera, and
the control unit drives the driving unit to enable the shooting direction of the camera to be defined according to the light type detected by the image processing unit.

15. The traffic information detecting apparatus according to claim 14, wherein
the image processing unit recognizes from the image of the road, the light type requiring a stop or deceleration of the vehicle, and
the control unit drives the driving unit to enable, via the camera, monitoring for a change in the light type.

16. The traffic information detecting apparatus according to claim 14, further comprising a sensor unit that detects a stop of the vehicle, wherein
the control unit drives the driving unit to enable, via the camera, monitoring for a change in the light type, after the sensor unit detects a stop of the vehicle.

17. The traffic information detecting apparatus according to claim 14, further comprising an information output unit, wherein
the image processing unit, after detecting a change in the light type of the traffic signal, causes the detection result to be output from the information output unit.

18. The traffic information detecting apparatus according to claim 14, wherein
the image processing unit executes predetermined image processing with respect to an initial image of the road to detect a road vanishing point, and
the control unit drives the driving unit to enable the road vanishing point detected by the image processing unit to be positioned at a predetermined position in the image of the road captured by the camera.

19. The traffic information detecting apparatus according to claim 18, wherein
the control unit drives the driving unit to constantly position the road vanishing point on a lower side of the image of the road captured by the camera, and
the image processing unit, to detect the traffic signal, executes predetermined image processing with respect to the image of the road captured by the camera.

20. The traffic information detecting apparatus according to claim 19, wherein the image processing unit performs detection of the traffic signal with respect to an area above the road vanishing point in the image of the road.

21. A traffic information detecting method comprising:
detecting a state of a traffic signal by predetermined processing of an image of the traffic signal captured by a camera; and
controlling a driving unit that defines a shooting direction of the camera, based on a detection result at the detecting, wherein
the detecting includes recognizing a light type of the traffic signal from an image of a road along which a vehicle is traveling, the image of the road being captured by the camera, and
the controlling includes controlling the driving unit to enable the shooting direction of the camera to be defined according to the light type detected at the detecting.

22. A computer-readable recording medium storing therein a traffic information detecting program that causes a computer to execute:
detecting a state of a traffic signal by predetermined processing of an image of the traffic signal captured by a camera; and
controlling a driving unit that defines a shooting direction of the camera, based on a detection result at the detecting, wherein
the detecting includes recognizing a light type of the traffic signal from an image of a road along which a vehicle is traveling, the image of the road being captured by the camera, and
the controlling includes controlling the driving unit to enable the shooting direction of the camera to be defined according to the light type detected at the detecting.
